(19) United States
(12) Patent Application Publication
(10) Pub. No.: US 2024/0263363 A1
(43) Pub. Date: Aug. 8, 2024

(54) COMBINATION STRUCTURE OF INTERIOR COMPONENTS

(71) Applicant: TOYOTA BOSHOKU KABUSHIKI KAISHA, Aichi (JP)

(72) Inventor: Tsuyoshi YAMAGUCHI, Nagoya-shi (JP)

(73) Assignee: TOYOTA BOSHOKU KABUSHIKI KAISHA, Aichi (JP)

(21) Appl. No.: 18/430,157

(22) Filed: Feb. 1, 2024

(30) Foreign Application Priority Data
Feb. 8, 2023 (JP) 2023-017429

(51) Int. Cl. D03D 11/00

(52) U.S. Cl. CPC D03D 11/00; D10B 2401/20

(57) ABSTRACT

A combination structure is a combination structure of a first interior component and a second interior component. The first interior component includes a base material and an upholstery material covering a surface of the base material. A protruding portion is provided extending from an outer edge of the base material. An outer edge portion of the upholstery material is laid on and wrapped around the protruding portion. The second interior component is provided with an insertion portion configured to receive insertion of the protruding portion.

### CROSS REFERENCE TO RELATED APPLICATIONS

The present application claims priority under 35 USC § 119 to Japanese Patent Application No. 2023-017429 filed on Feb. 08, 2023, the disclosure of which is hereby expressly incorporated by reference in its entirety.

### BACKGROUND OF THE INVENTION

### (1) Field of the Invention

The present invention relates to a combination structure of interior components, and more specifically to a combination structure of a first interior component and a second interior component.

### (2) Description of Related Art

As a combination structure of interior components in the related art, a combination structure of a first interior component and a second interior component, which constitute a vehicle door trim, is generally known (refer to, for example, JP 2018-197083 A). As the first interior component, JP 2018-197083 A describes adoption of a component obtained by affixing an optical fiber upholstery material interwoven with optical fiber onto a base material. For this type of combination structure of a first interior component and a second interior component, adoption of an overlaid structure (refer to FIG. 10(a)) in which a second interior component 102 (peripheral component) is overlaid from a design surface side of a first interior component 101, or a joggled structure (refer to FIG. 10(b)) in which the first interior component 101 and the second interior component 102 are assembled by fitting the first interior component 101 from a back surface side of the second interior component 102 is recommended.

Alternatively, an overlaid structure in which the second interior component is overlaid from a back surface side of the first interior component, or a joggled structure 100S (refer to FIG. 11(a)) in which the first interior component 101 and the second interior component 102 are assembled by fitting the first interior component 101 from a design surface side of the second interior component 102 may also be adopted. In these structures, when the first interior component is manufactured, an outer edge portion of the optical fiber upholstery material needs to be wrapped around to a back surface of the base material to improve the appearance. In the joggled structure 100S described above in particular, to eliminate wrinkles in an optical fiber upholstery material 105 at an acute angle portion 106 of a base material 104, the optical fiber upholstery material 105 needs to be wrapped around while strongly pulling an outer edge portion 105a of the optical fiber upholstery material 105, as illustrated in FIG. 11(b).

However, in the joggled structure 100S described above, when manufacturing the first interior component 101, since the optical fiber upholstery material 105 needs to be wrapped around to the back surface at the acute angle portion 106 of the base material 104 while strongly pulling the outer edge portion 105a of the optical fiber upholstery material 105, a phenomenon may arise in which the optical fiber upholstery material 105 is partially crushed, which reduces the thickness of the sheet or distorts the design surface in the pulling direction. Note that an upholstery material including no optical fiber may also be subject to the above problem in substantially the same manner. The above problem may also occur substantially in the same manner at an obtuse angle portion of the base material.

### SUMMARY OF THE INVENTION

Embodiments of the present invention have been made in light of the circumstances described above, and an object thereof is to provide a combination structure of interior components with which a first interior component and a second interior component can be combined in a manner that helps prevent deterioration of design quality of an upholstery material.

Embodiments of the present invention are as follows.

1. A combination structure of interior components is a combination structure of a first interior component and a second interior component. The first interior component includes a base material and an upholstery material covering a surface of the base material. A protruding portion is provided extending from an outer edge of the base material, an outer edge portion of the upholstery material being laid on and wrapped around the protruding portion. The second interior component is provided with an insertion portion configured to receive insertion of the protruding portion.

2. In the combination structure of interior components according to 1 described above, the protruding portion is provided on one side of the base material.

3. In the combination structure of interior components according to 1 described above, the protruding portion is provided at or near a round portion connecting two sides of the base material.

4. In the combination structure of interior components according to 3 described above, an angle formed by the two sides of the base material is an acute angle.

5. In the combination structure of interior components according to 1 described above, the upholstery material includes a woven fabric obtained by interweaving optical fiber as a constituent yarn.

According to a combination structure of interior components of the present embodiment, the first interior component includes the base material and the upholstery material covering the surface of the base material, a protruding portion is provided extending from an outer edge of the base material, an outer edge portion of the upholstery material being laid on and wrapped around the protruding portion, and the second interior component is provided with the insertion portion configured to receive insertion of the protruding portion. Accordingly, when the first interior component is manufactured, the outer edge portion of the upholstery material is laid on and wrapped around the protruding portion disposed shifted to a design outer side of the first interior component, thereby suppressing the occurrence of a defect in the design surface of the upholstery material. Thus, by inserting the protruding portion of the first interior component into the insertion portion of the second interior component, the first interior component and the second interior component can be combined in a manner that helps prevent deterioration of design quality of the upholstery material.

### BRIEF DESCRIPTION OF THE DRAWINGS

The present invention will be further described in the following detailed description with reference to the following figures, given non-limiting examples of exemplary embodiments according to the invention, and like reference symbols represent identical parts through several figures.

FIG. 1 is a front view of a vehicle door trim according to an embodiment, as viewed from a vehicle interior side.

FIG. 2 is an explanatory view of a combination structure of interior components according to the embodiment, where (a) illustrates an enlarged view of a main portion of FIG. 1, (b) illustrates an enlarged cross-sectional view taken along line b-b, and (c) illustrates an enlarged cross-sectional view taken along line c-c.

FIG. 3 is an explanatory view of the combination structure of interior components, where (a) illustrates a plan view from a front surface of a first interior component, (b) illustrates a plan view from a front surface of a second interior component, and (c) illustrates a plan view from a front surface of an assembled state of the first interior component and the second interior component.

FIG. 4 is an explanatory view of the first interior component, where (a) illustrates a plan view of a main portion viewed from a front surface of a base material, (b) illustrates a plan view of the main portion viewed from the front surface of the first interior component, and (c) illustrates a plan view of the main portion viewed from a back surface of the first interior component.

FIG. 5 is an explanatory view of the first interior component.

FIG. 6 is a perspective view of a main portion viewed from the surface of the second interior component.

FIG. 7 is an explanatory view of a combination structure of interior components according to another embodiment, where (a) illustrates a form in which a protruding portion having an elongated shape is provided along one side of the base material, and (b) illustrates a form in which the protruding portion is provided across two sides of the base material.

FIG. 8 is an explanatory view of a combination structure of interior components according to yet another embodiment, where (a) illustrates a form in which the protruding portion is extended to an outer edge of the base material without a stepped portion interposed therebetween, and (b) illustrates a form in which the protruding portion is extended toward a back surface side of the base material.

FIG. 9 is an explanatory view of a combination structure of interior components according to yet another embodiment, where (a) is a plan view of a main portion viewed from the front surface of the base material, and (b) is a plan view of a main portion viewed from the front surface of the first interior component.

FIG. 10 is an explanatory view of a combination structure of interior components in the related art, where (a) illustrates an overlaid structure, and (b) illustrates a joggled structure.

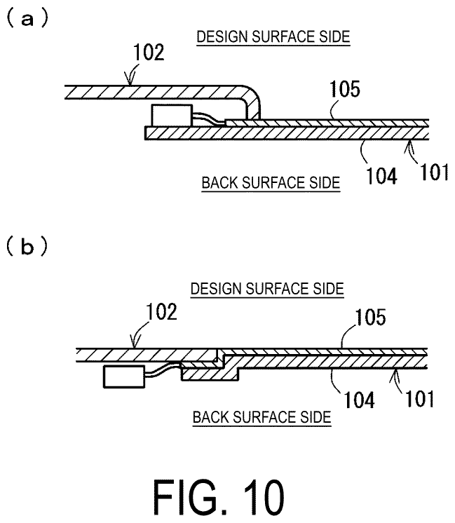

FIG. 11 is an explanatory view of the joggled structure in the related art, where (a) illustrates a cross-sectional view of a main portion, and (b) illustrates a plan view of the main portion as viewed from a front surface of a first interior component.

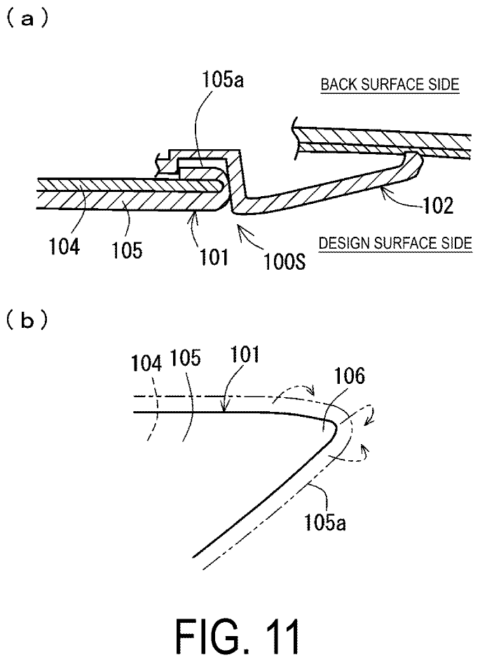

### DESCRIPTION OF EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

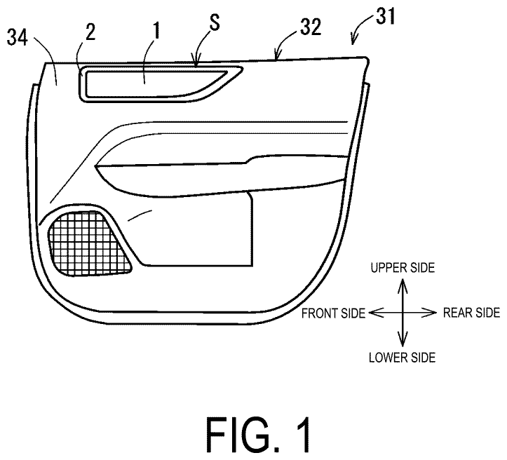

Hereinafter, the present invention will be described in detail in the form of embodiments with reference to the drawings. Note that, in the present embodiment, as illustrated in FIG. 1, a first interior component 1 and a second interior component 2 (also referred to as “decorative components”) constituting a vehicle door trim 31 are given as an example of “interior components” according to the present invention. Furthermore, in the following description, front surfaces of the first and second interior components 1, 2 refer to design surfaces, and back surfaces of the first and second interior components 1, 2 refer to surfaces opposite to the design surfaces.

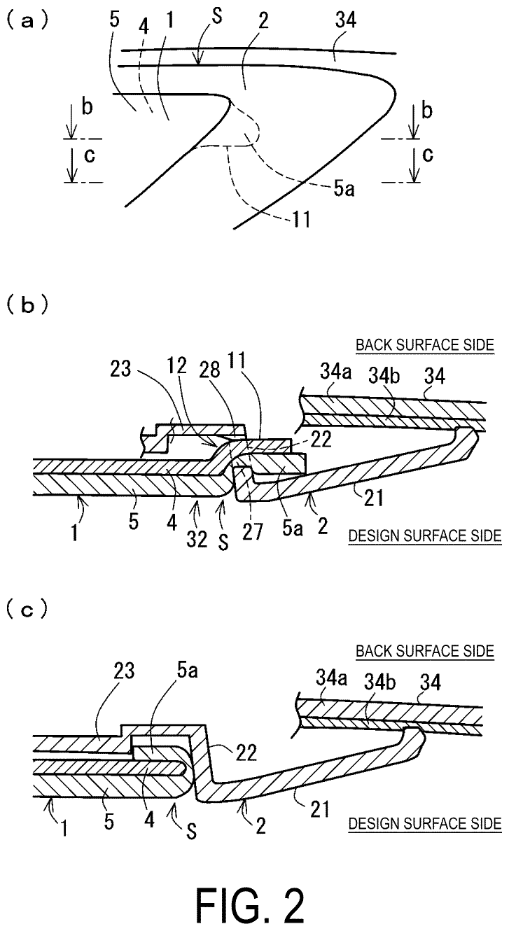

The vehicle door trim 31 includes a trim main body 32 that covers an inner panel (not illustrated) made of metal from a vehicle interior side. The trim main body 32 includes the first interior component 1, the second interior component 2, and an upper board 34, which form the design surface on the vehicle interior side. The upper board 34 includes a base material 34a made of a synthetic resin and an upholstery material 34b covering a front surface of the base material 34b (refer to FIG. 2).

As illustrated in FIG. 1 and FIG. 2, a combination structure S of interior components according to the present embodiment is the combination structure S of the first interior component 1 and the second interior component 2. Specifically, the combination structure S is a joggled structure in which the first interior component 1 and the second interior component 2 are assembled by fitting the first interior component 1 from the design surface side of the second interior component 2 such that the design surfaces of the first interior component 1 and the second interior component 2 are continuous in a substantially flush manner. However, a structure in which the first interior component 1 and the second interior component 2 are assembled by fitting the first interior component 1 from the design surface side of the second interior component 2 such that the design surfaces are continuous in a stepped manner may also be adopted.

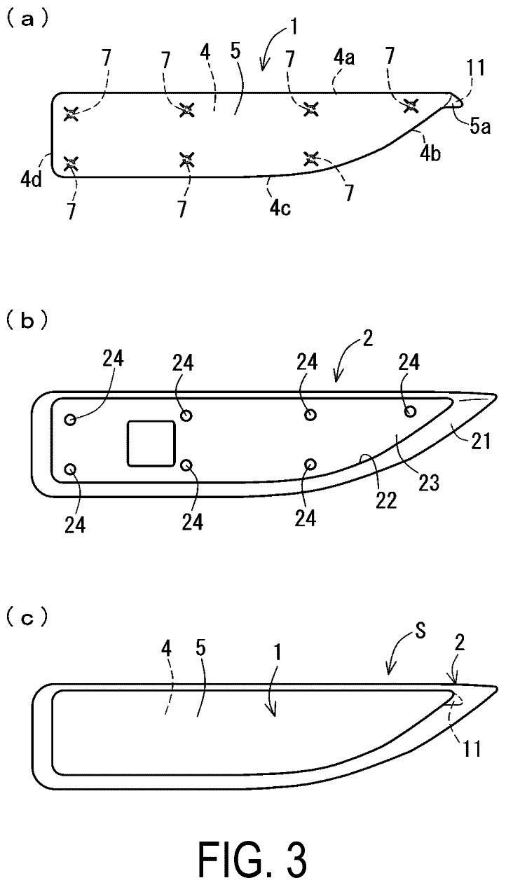

The first interior component 1 includes a base material 4 and an upholstery material 5 covering a front surface of the base material 4. The base material 4 is made of a synthetic resin. Further, as illustrated in FIG. 3(a), the base material 4 is formed in a sheet shape (specifically, an elongated sheet shape). Further, the planar shape of the base material 4 is a polygon (specifically, a quadrangle) having a plurality of sides 4a to 4d. Further, bosses 7 for attaching the first interior component 1 to the second interior component 2 are provided on a back surface of the base material 4.

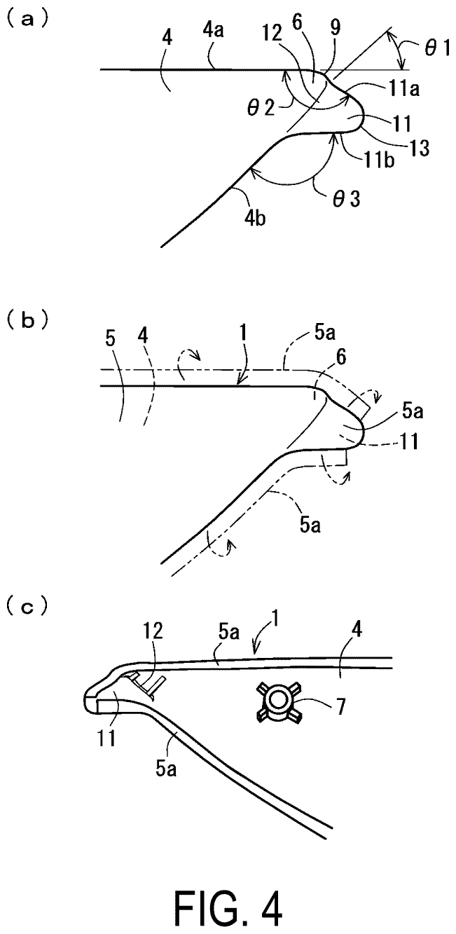

As illustrated in FIG. 4, the two sides 4a, 4b of the base material 4 are connected via a round portion 9 (arc-shaped portion). An angle θ1 formed by the two sides 4a, 4b of the base material 4 is an acute angle (e.g., 40 degrees). A radius of curvature of the round portion 9 is set to a relatively small value (e.g., a value equal to or less than 10 mm). Furthermore, in the base material 4, an acute angle portion 6 is formed at a part surrounded by the two sides 4a, 4b and the round portion 9.

A protruding portion (tongue-like portion) 11 is provided extending from an outer edge of the base material 4. An outer edge portion 5a of the upholstery material 5 is laid on and wrapped around the protruding portion 11. The protruding portion 11 is provided at or near the round portion 9 connecting the two sides 4a, 4b of the base material 4. The protruding portion 11 is also provided on the one side 4b of the two sides 4a, 4b of the base material 4. Furthermore, the protruding portion 11 is connected to the base material 4 via a stepped portion 12 so as to be continuous with the base material 4 in a stepped manner in a thickness direction of the base material 4 (refer to FIG. 2(b)).

The protruding portion 11 extends toward an outer side of the base material 4 (that is, a design outer side of the first interior component 1). Further, the protruding portion 11 has one side 11a continuous with the round portion 9 of the base material 4, one side 11b continuous with the one side 4b of the base material 4, and a connecting portion 13 connecting the two sides 11a, 11b. An angle θ2 formed by the one side 11a of the protruding portion 11 and the one side 4a of the base material 4 is set to a value (specifically, an obtuse angle) greater than the angle θ1 formed by the two sides 4a, 4b of the base material 4. An angle θ3 formed by the one side 11b of the protruding portion 11 and the one side 4b of the base material 4 is set to a value (specifically, an obtuse angle) greater than the angle θ1 formed by the two sides 4a, 4b of the base material 4. Furthermore, the connecting portion 13 is formed in an arc shape.

The upholstery material 5 is formed to a size that covers the entire front surface of the base material 4. Further, the outer edge portion 5a of the upholstery material 5 is wrapped around to the back surface of the base material 4 and affixed to the back surface with an adhesive or the like. Specifically, at the protruding portion 11 of the base material 4, the outer edge portion 5a of the upholstery material 5 is laid on the front surface of the protruding portion 11 and wrapped around to the back surface (refer to FIG. 4 and FIG. 2(b)). Furthermore, at parts of the base material 4 other than the protruding portion 11, the outer edge portion 5a of the upholstery material 5 is laid on the front surface of the base material 4 and wrapped around to the back surface (refer to FIG. 2(c)).

Note that there is no particular limitation on factors such as the wrapping margin of the upholstery material 5 with respect to the base material 4 and the protruding portion 11. Furthermore, the outer edge portion 5a of the upholstery material 5 may be laid on the entire front surface of the protruding portion 11, or the outer edge portion 5a of the upholstery material 5 may be laid on a portion of the front surface of the protruding portion 11.

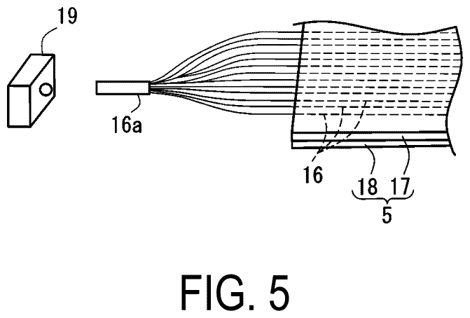

As illustrated in FIG. 5, the upholstery material 5 includes a woven fabric 17 obtained by interweaving optical fiber 16 (specifically, the side emission type optical fibers 16) as a constituent yarn. Furthermore, the upholstery material 5 includes a cushion layer 18 layered on a back surface of the woven fabric 17. The material of the cushion layer 18 is not particularly limited, but a sheet material made of soft polyurethane foam is often used. Other soft resin foams can also be used as long as the foam has sufficient cushioning properties.

The optical fibers 16 are exposed (extends) from an end portion of the upholstery material 5. Exposed endmost sides of the optical fibers 16 are bound by a sleeve, a heat-shrinkable tube, or the like to form a bound portion 16a. Light of a light source 19 enters from the bound portion 16a of the optical fibers 16 and exits from the front surface of the upholstery material 5, thereby causing the first interior component 1 to emit light.

Note that the woven fabric 17 is a fabric woven from constituent yarns (warp yarns and weft yarns), and the weave structure thereof is not particularly limited. Specifically, various weave structures such as plain weave, twill weave, and satin weave can be adopted. Further, as the optical fiber 16, various optical fibers having a core-sheath structure (multilayer structure) of a core (core layer) and a sheath (cladding layer) in which the refractive index of the core layer differs from the refractive index of the cladding layer can be adopted. The optical fiber 16 may 16 may also be of a side emission type in which light entering from one end side exits from a portion or all of a peripheral surface, or of an end emission type in which light entering from one end side exits from the other end side. Additionally, the optical fiber 16 is used for at least one of the warp yarn and the weft yarn constituting the woven fabric 17. Particularly, the optical fiber 16 can be used for the weft yarn. Furthermore, the constituent yarn other than the optical fiber 16 that constitutes the woven fabric 17 (hereinafter also referred to as “other constituent yarn”) is not particularly limited to any type. For example, a yarn made of a natural fiber of plant or animal origin, a regenerated fiber such as rayon, a semi-synthetic fiber such as acetate, or a synthetic fiber made of synthetic resin can be used.

The second interior component 2 is made of a synthetic resin. Further, as illustrated in FIG. 2 and FIG. 3, the second interior component 2 is formed in a frame shape. More specifically, the second interior component 2 includes a frame wall 21 forming a design surface, and a lateral wall 22 extending from an inner peripheral side of the frame wall 21 toward the back surface side. The second interior component 2 also includes a bottom wall 23 that is continuous with an endmost side of the lateral wall 22. An outer edge portion of the frame wall 21 abuts against a front surface of the upper board 34. Further, the lateral wall 22 and the bottom wall 23 form a space for accommodating the first interior component 1. Further, insertion holes 24 through which the bosses 7 of the first interior component 1 are inserted are formed in the bottom wall 23. The first interior component 1 and the second interior component 2 are integrated by inserting the bosses 7 into the insertion holes 24 and fastening the bosses 7 with screws or the like.

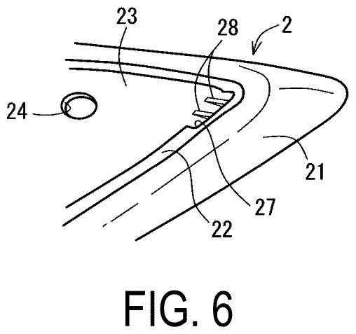

As illustrated in FIG. 2 and FIG. 6, the second interior component 2 (specifically, the lateral wall 22) is provided with an insertion portion (insertion opening) 27. The protruding portion 11, on and around which the outer edge portion 5a of the upholstery material 5 is laid and wrapped, is inserted into the insertion portion 27. The insertion portion 27 is constituted by a through hole. The insertion portion 27 is provided with a rib 28 for positioning and holding the protruding portion 11 and the outer edge portion 5a of the upholstery material 5. Additionally, an opening width of the insertion portion 27 is set to a value slightly greater than a lateral width of the protruding portion 11.

Note that, as the insertion portion 27, an insertion portion constituted by a recessed portion may be adopted. Furthermore, the protruding portion 11 and the outer edge portion 5a of the upholstery material 5 may be positioned and held by way of a set opening height of the insertion portion 27, without providing the rib 28.

Next, actions and effects of the combination structure S of interior components having the configuration described above will be described. When manufacturing the first interior component 1, the front surface of the base material 4 is covered with the upholstery material 5, and the outer edge portion 5a of the upholstery material 5 is wrapped around to the back surface of the base material 4 and affixed to the back surface by an adhesive or the like. At this time, the outer edge portion 5a of the upholstery material 5 is laid on and wrapped around the protruding portion 11 disposed shifted to the design outer side of the first interior component 1 (refer to FIG. 4). In the wrapping, since the angles θ2, θ3 formed by the sides 11a, 11b of the protruding portion 11 and the sides 4a, 4b of the base material 4, respectively, are obtuse angles, the outer edge portion 5a of the upholstery material 5 can be wrapped around and affixed to the back surface of the protruding portion 11 by being slightly bent. This helps prevent the occurrence of defects (e.g., wrinkles, crushing, or distortion) in the design surface of the upholstery material 5 at the acute angle portion 6 of the base material 4.

The protruding portion 11 of the first interior component 1 thus manufactured is inserted into the insertion portion 27 of the second interior component 2, and the first interior component 1 is arranged inside the second interior component 2 having a frame shape to integrate the first and second interior components 1, 2. At this time, the entire periphery of the outer edge portion of the first interior component 1 is pressed into contact with the lateral wall 22 of the second interior component 2, whereby the upholstery material 5 is compressed in a thickness direction and the first interior component 1 and the second interior component 2 are combined in a state of close contact (refer to FIG. 2).

As described above, according to the combination structure S of interior components of the present embodiment, the first interior component 1 includes the base material 4 and the upholstery material 5 covering the front surface of the base material 4. The protruding portion 11 is provided extending from an outer edge of the base material 4, and the outer edge portion 5a of the upholstery material 5 is laid on and wrapped around the protruding portion 11. The second interior component 2 is provided with the insertion portion 27 configured to receive insertion of the protruding portion 11. Thus, when manufacturing the first interior component 1, the outer edge portion 5a of the upholstery material 5 is laid on and wrapped around the protruding portion 11 disposed shifted to the design outer side of the first interior component 1. This helps prevent the occurrence of a defect in the design surface of the upholstery material 5. Accordingly, when the protruding portion 11 of the first interior component 1 is inserted into the insertion portion 27 of the second interior component 2, the first interior component 1 and the second interior component 2 can be combined in a manner that helps prevent deterioration of the design quality of the upholstery material 5.

Further, in the present embodiment, the protruding portion 11 is provided on the one side 4b of the plurality of sides 4b to 4d of the base material 4. Thus, the first interior component 1 and the second interior component 2 having a frame shape can be easily assembled.

Further, in the present embodiment, the protruding portion 11 is provided at or near the round portion 9 connecting the two sides 4a, 4b of the base material 4, and the angle θ1 formed by the two sides 4a, 4b of the base material 4 is an acute angle. This configuration helps prevent the occurrence of defects in the design surface of the upholstery material 5 at the acute angle portion 6 of the base material 4.

Further, in the present embodiment, the upholstery material 5 includes the woven fabric 17 obtained by interweaving the optical fiber 16 as a constituent yarn. This configuration helps prevent deterioration of the design quality of the upholstery material 5 made of optical fiber (in particular, the light emission of the upholstery material 5 made of optical fiber).

Furthermore, in the present embodiment, the angles θ2, θ3 formed by the sides 11a, 11b of the protruding portion 11 and the sides 4a, 4b of the base material 4, respectively, are each greater than the angle θ1 formed by the two sides 4a, 4b of the base material 4. Thus, the outer edge portion 5a of the upholstery material 5 can be easily wrapped around the protruding portion 11.

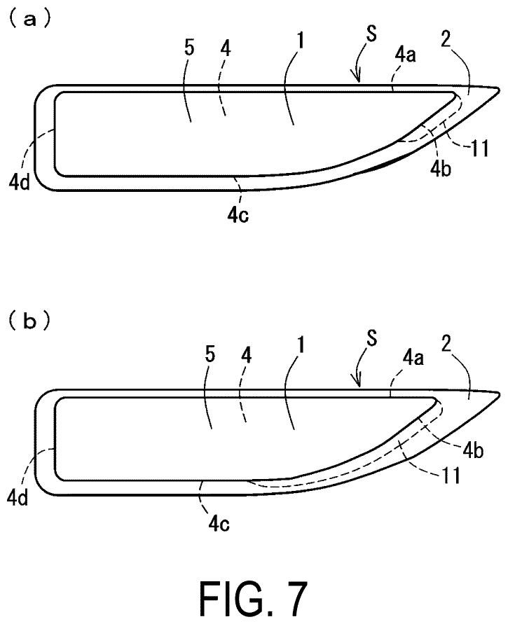

Note that the present invention is not limited to the embodiments described above, and various modifications can be made within the scope of the present invention in accordance with the purpose and application. That is, in the embodiments described above, the protruding portion 11 is provided at the end portion of the one side 4b of the base material 4 as an example. However, no such limitation is intended, and, for example, the protruding portion 11 may be provided in an elongated shape along the one side 4b of the base material 4, as illustrated in FIG. 7(a).

Further, in the embodiments described above, the protruding portion 11 is provided only on the one side 4b of the base material 4 as an example. However, no such limitation is intended, and, for example, the protruding portion 11 may be provided across the two sides 4b, 4c of the base material 4, as illustrated in FIG. 7(b).

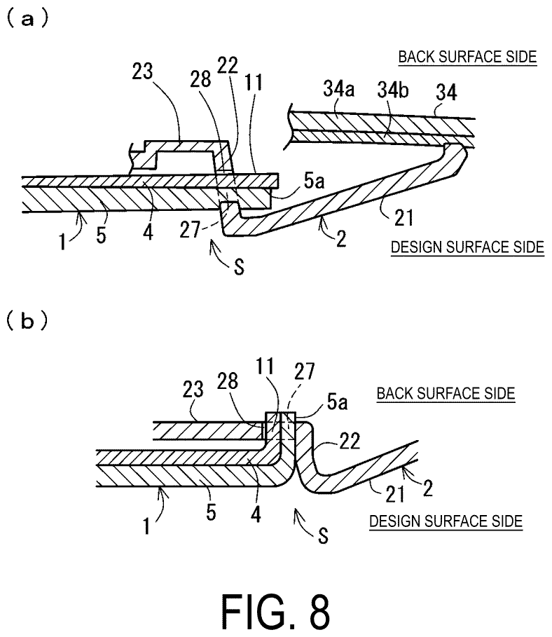

Further, in the embodiments described above, the protruding portion 11 is connected to the outer edge of the base material 4 with the stepped portion 12 interposed therebetween as one example. However, no such limitation is intended, and, for example, the protruding portion 11 may be directly connected to the outer edge of the base material 4 without providing the stepped portion 12, as illustrated in FIG. 8(a).

Further, in the embodiments described above, the protruding portion 11 extends toward the outer side of the base material 4 as an example. However, no such limitation is intended, and, for example, the protruding portion 11 may extend toward the back surface side (that is, the design outer side of the first interior component 1) of the base material 4, as illustrated in FIG. 8(b).

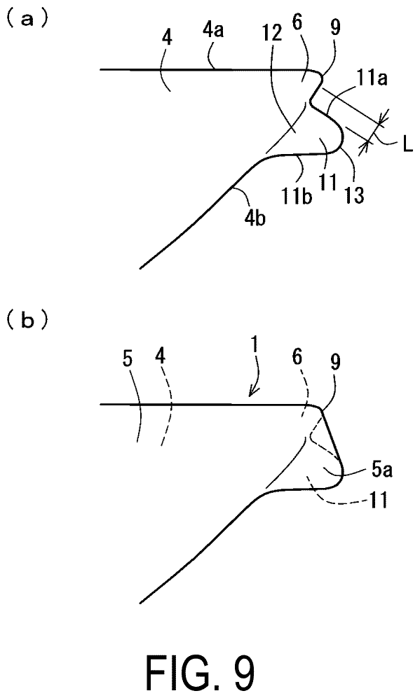

Further, in the embodiments described above, the protruding portion 11 has the one side 11a continuous with the round portion 9 of the base material 4 as an example. However, no such limitation is intended, and, for example, the protruding portion 11 may be provided at or near the round portion 9 of the base material 4 such that a space L between the one side 11a of the protruding portion 11 and one end of the round portion 9 is 30 mm or less (preferably 20 mm, particularly preferably 10 mm), as illustrated in FIG. 9. Alternatively, the protruding portion 11 may be provided away from the round portion 9 of the base material 4 such that the space L between the one side 11a and one end of the round portion 9 is greater than 30 mm.

Further, in the embodiments described above, the entire periphery of the outer edge portion 5a of the upholstery material 5 is wrapped around to the back surface of the base material 4 as an example. However, no such limitation is intended, and, for example, a portion of the outer edge portion 5a of the upholstery material 5 may be wrapped around to the back surface of the base material 4.

Further, in the embodiments described above, the angle θ1 formed by the two sides 4a, 4b of the base material 4 is an acute angle and the protruding portion 11 is provided on one side as an example. However, no such limitation is intended, and, for example, the angle θ1 formed by the two sides 4a, 4b of the base material 4 may be an obtuse angle and the protruding portion 11 may be provided on one side.

Further, in the embodiments described above, the upholstery material 5 including the woven fabric 17 is obtained by interweaving the optical fiber 16 as a constituent yarn as an example. However, no such limitation is intended, and, for example, the upholstery material 5 including a woven fabric or a knitted fabric in which the optical fiber 16 is not interwoven as a constituent yarn may be used.

Furthermore, in the embodiments described above, the interior components 1, 2 constitute the vehicle door trim 31 as an example. However, no such limitation is intended, and, for example, the interior components may constitute a conveyance product (e.g., product for vehicle, aircraft, ship etc.) such as an instrument panel, a roof trim, a floor trim, a luggage trim, a rear side trim, a rear shell, a cargo shelf, a pillar garnish, a switch base, a quarter panel, an armrest, a center console, an overhead console, a sun visor, or a seat. Furthermore, the interior components may constitute furniture, such as a sofa or a chair.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is widely utilized as a technique for combining a first interior component and a second interior component.

1. A combination structure of interior components, the combination structure being obtained by combining a first interior component and a second interior component,
wherein the first interior component includes
a base material, and
an upholstery material covering a surface of the base material,
a protruding portion is provided extending from an outer edge of the base material, an outer edge portion of the upholstery material being laid on and wrapped around the protruding portion, and
the second interior component is provided with an insertion portion configured to receive insertion of the protruding portion.

2. The combination structure of interior components according to claim 1, wherein the protruding portion is provided on one side of the base material.

3. The combination structure of interior components according to claim 1, wherein the protruding portion is provided at or near a round portion connecting two sides of the base material.

4. The combination structure of interior components according to claim 3, wherein an angle formed by the two sides of the base material is an acute angle.

5. The combination structure of interior components according to claim 1, wherein the upholstery material includes a woven fabric obtained by interweaving optical fiber as a constituent yarn.
